(19) United States
(12) Patent Application Publication
(10) Pub. No.: US 2026/0230754 A1
(43) Pub. Date: Aug. 6, 2026

(54) Audio Rendering Optimization Based on Loudspeaker Layout

(71) Applicant: Samsung Electronics Co., Ltd., Suwon-si (KR)

(72) Inventors: Toni Mikael Hirvonen, Santa Clarita, CA (US); Carlos Tejeda Ocampo, Gutierrez (MX); Sunil Bharitkar, Stevenson Ranch, CA (US); Alejandro Cajica Contreras, Puebla (MX)

(21) Appl. No.: 19/318,885

(22) Filed: Sep. 4, 2025

Related U.S. Application Data
(60) Provisional application No. 63/753,371, filed on Feb. 3, 2025.

(51) Int. Cl. H04R 5/04

(52) U.S. Cl. CPC H04R 5/04; H04R 2205/024

(57) ABSTRACT

In one embodiment, a method includes accessing input audio for playback on a set of loudspeakers having a particular layout in a listening space; and determining, based on the particular layout of the set of loudspeakers in the listening space, whether the particular layout is a custom layout that differs from a default layout associated with a default renderer for generating output audio for playback on the set of loudspeakers. The method further includes in response to a determination that the particular layout comprises a custom layout, then selecting, based on the particular layout of the set of loudspeakers, a modified renderer for generating output audio for playback on the set of loudspeakers; and rendering the input audio using the selected modified renderer to generate the output audio for playback on the set of loudspeakers.

### PRIORITY CLAIM

This application claims the benefit under 35 U.S.C. § 119 of U.S. Provisional Patent Application No. 63/753,371 filed Feb. 3, 2025, which is incorporated by reference herein.

### TECHNICAL FIELD

This application generally relates to audio rendering optimization based on loudspeaker layout.

### BACKGROUND

A loudspeaker converts an electrical audio signal into a corresponding sound. Loudspeakers can be used for playing music, listening to audio content corresponding to video content (e.g., audio of a TV show or a movie), etc. An entertainment system often involves multiple loudspeakers that play audio. For example, an entertainment system may include a pair of left-right stereo loudspeakers, a subwoofer, a center loudspeaker, a pair of left-right surround loudspeakers, and/or a pair of left-right rear surround loudspeakers. The number of loudspeakers in a system are often referred to by an x.y convention, where x is the number of loudspeakers used in the system and y refers to the number of subwoofers used in the system.

In order to optimize sound quality, loudspeakers in an entertainment system are designed to have a specific placement relative to a listener. For instance, an ideal angle and distance from each loudspeaker to a listener may be specified, for example by the recommendations set forth in the ITU-R BS.2159-4 standard. Audio may be created and rendered for playback under the assumption that loudspeaker positions are at or near a particular specified placement in a listening space.

### BRIEF DESCRIPTION OF THE DRAWINGS

FIG. 1 illustrates an example method for selecting a renderer for input audio based on the particular layout of a set of loudspeakers.

FIG. 2 illustrates an example implementation of the method of FIG. 1.

FIG. 3 illustrates an example implementation of a particular rendering selection process

FIG. 4 illustrates example aspects of certain embodiments implementing the techniques of FIG. 1.

FIG. 5 illustrates an example computing system.

### DESCRIPTION OF EXAMPLE EMBODIMENTS

To reproduce audio from a set of loudspeakers, a specific algorithm called a renderer is used to transform the input audio to output audio for a particular listening layout for a set of loudspeakers, such as headphones, home theater systems, and so on. Input audio typically comes in one of three variants: (1) channel-based audio, where audio input tracks are mostly directly routed to output channels, or are treated as static objects (2) scene-based audio, where captured spatial audio is first transformed to channel-based for rendering and (3) object-based audio, where input audio tracks have spatial properties described by metadata. Rendering algorithms are typically amplitude-based, but may be time-frequency based, in which loudspeaker gains (or masks) are calculated to optimize spatial attributes (e.g. perceived direction).

One of the most popular types of metadata describing spatial properties of input audio is Cartesian metadata, which represents objects in Cartesian coordinates. The renderer is then typically an allocentric renderer, which attempts to reproduce an approximation of the desired spatial impression to a relatively larger listening area. In contrast, egocentric renderers attempt to render audio for a more accurate spatial reproduction at a particular “sweet spot.” Allocentric rendering therefore tends to be better suited to, e.g., cinemas and large listening rooms, while egocentric rendering tends to perform better on relatively smaller listening spaces (e.g., rooms in a home, or in a car, etc.).

Another rendering technique involve distance-based amplitude panning, or DBAP. This rendering technique bases loudspeaker gains on relative Cartesian distances, or center-of-mass weighting, between the loudspeaker and source object locations. However, DBAP techniques are prone to distortions in spatial perception caused by, e.g., the precedence effect: as the listener position is not optimized for, the perceived direction can collapse to the loudspeaker closest to the listening position regardless of the intended rendering. These issues are most acute in, e.g., home environments where users set up speakers without strict adherence to placement specifications. In addition, DBAP techniques can be unintuitive for content creators, and therefore tends to be disfavored relative to allocentric rendering.

Rendering techniques, including allocentric rendering, require a specific layout for a set of loudspeakers that will play the rendered input audio. For example, the relative positions and distances between front speakers, a center speaker, and rear speakers is often precisely specified, e.g., by an audio standard, for a particular rending technique in order for that technique to provide satisfactory auditory results in the listening space. However, particularly in consumer settings, the actual speaker layout deviates from these specified layouts, resulting in a degraded audio experience upon playback.

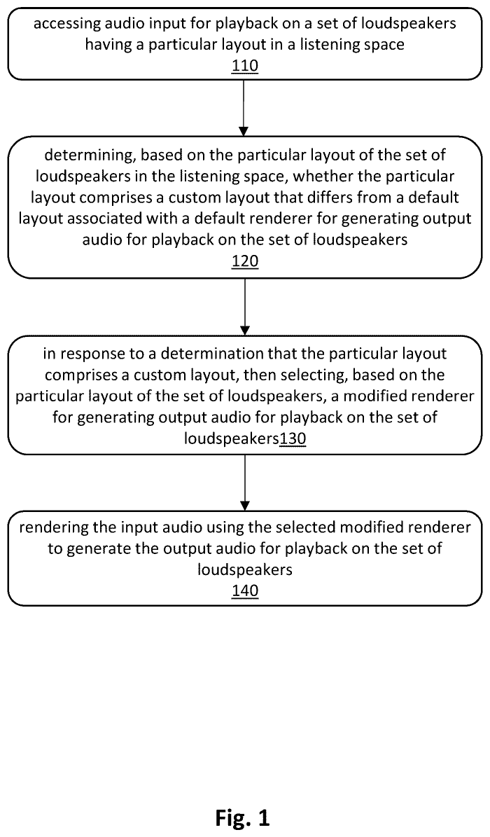

FIG. 1 illustrates an example method for selecting a renderer for input audio based on the particular layout of a set of loudspeakers. Step 110 of the example method of FIG. 1 includes accessing audio input for playback on a set of loudspeakers having a particular layout in a listening space. The listening space may be a room or a space in, e.g., a car, etc. As described above, a layout (the relative positions of the speakers in the set of loudspeakers) in a listening space often varies from an idealized layout for that set of loudspeakers, and there are limitless variations that can occur, as listening rooms and user placements can vary greatly from setup to setup. The input audio can take any suitable form, such as those described above.

Step 120 of the example method of FIG. 1 includes determining, based on the particular layout of the set of loudspeakers in the listening space, whether the particular layout is a custom layout that differs from a default layout associated with a default renderer for generating output audio for playback on the set of loudspeakers. In particular embodiments, the particular layout may be identified by a user, for example by specifying each position or relative position of each speaker in the set of loudspeakers. In particular embodiments, the particular layout may be automatically determined, for example by playing one or more test audio sounds from the set of loudspeakers (e.g., from one or more speakers in the set at a time) and then recording the audio, e.g., at one or more predetermined locations (for example, using one or more microphones built in to some or all of the loudspeakers, although other microphone positions may be used).

In particular embodiments, the particular layout for a given set of loudspeakers may be identified as a custom layout based on a difference between that particular layout and a specified layout associated with a default renderer, which is typically used with the particular type of input audio. For instance, as described above, input audio that uses Cartesian metadata is typically accompanied by an allocentric renderer, although at times a DBAP renderer may be used as the default. The specified layout associated with a default renderer may depend on the particular set of loudspeakers used; for example, a set of 5.1 loudspeakers may have one specified layout, while a set of 7.1 loudspeakers uses a different layout particular to that set.

The differences between a particular layout and a default layout may be based on, for example, a difference between the positions of one or more loudspeakers in the particular layout and the positions of corresponding loudspeakers in the default layout. For example, a 5.1 loudspeaker system may have a certain specification for speaker placement. A deviation in speaker placement in the particular layout relative to the default, or idealized, specification for that speaker system results in the particular layout being determined to be a custom layout. For example, if one or more loudspeakers in a particular layout are beyond a tolerance from their respective placements in a corresponding specification for that speaker system, then the particular layout may be determined to be a custom layout. The tolerance may be based on, for example, a percentage deviation or a raw value.

In particular embodiments, a tolerance may be based on localization blur associated with hearing perception. For instance, localization blur occurs because human hearing does not precisely and exactly localize audio heard by the listener. Instead, there is a localization blur where the auditory perception corresponds to a certain direction for sound sources displaced around the auditory perceived location. For instance, in the horizontal plane a sound source is typically perceived as occurring at 90 degrees for a sound source anywhere between 90 degrees and 70 degrees to the left-side of a listener. In the median plane a sound source at 36 degrees can be perceived as occurring anywhere between 40 and 50 degrees. These examples illustrate how localization blur varies based on the relative orientation of a sound to the listener; for example, typical localization blur values are around 3.6 degrees for a sound that occurs in front of a listener (i.e., a sound that occurs directly in front of the listener (0 degrees) will be perceived as occurring at the same location as a sound that is located +/−3.6 degrees from 0 degrees), while localization blur is larger (e.g., +/−~10 degrees) for sounds that occur at the sides of a listener.

In particular embodiments, if one or more loudspeakers (e.g., a preset number of loudspeakers) are outside of a respective localization blur relative to a specified location for that loudspeakers set, then a particular layout may be determined to be a custom layout.

Step 130 of the example method of FIG. 1 includes in response to a determination that the particular layout comprises a custom layout, then selecting, based on the particular layout of the set of loudspeakers, a modified renderer for generating output audio for playback on the set of loudspeakers. In other words, when a particular layout is determined to be a custom layout relative to a default layout of a default renderer, then this determination triggers selection of a modified renderer to use for the input audio. In addition, selection of the modified renderer is based on the custom layout itself.

For example, a modified renderer may include an egocentric renderer, for example by interpreting Cartesian metadata for input audio using a Cartesian-to-polar coordinate conversion, such as is specified in Rec. ITU-R BS. 2127-1, Sec 10.1.2. The input audio that is converted to polar coordinates then may be used along with an egocentric renderer to render the input audio for playback on the set of loudspeakers. This is one example of Step 140 of the example method of FIG. 1, which includes rendering the input audio using the selected modified renderer to generate the output audio for playback on the set of loudspeakers. In particular embodiments, an egocentric rendering technique may be modified by aligning the loudspeakers with delays for localized position listening, in order to determine where the egocentric “sweet spot” is.

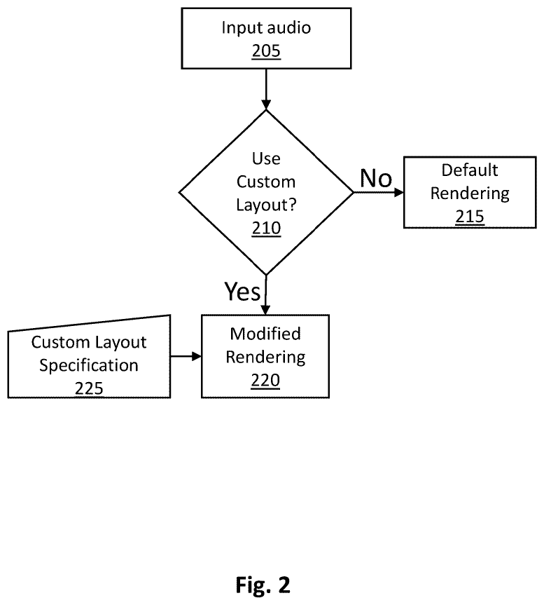

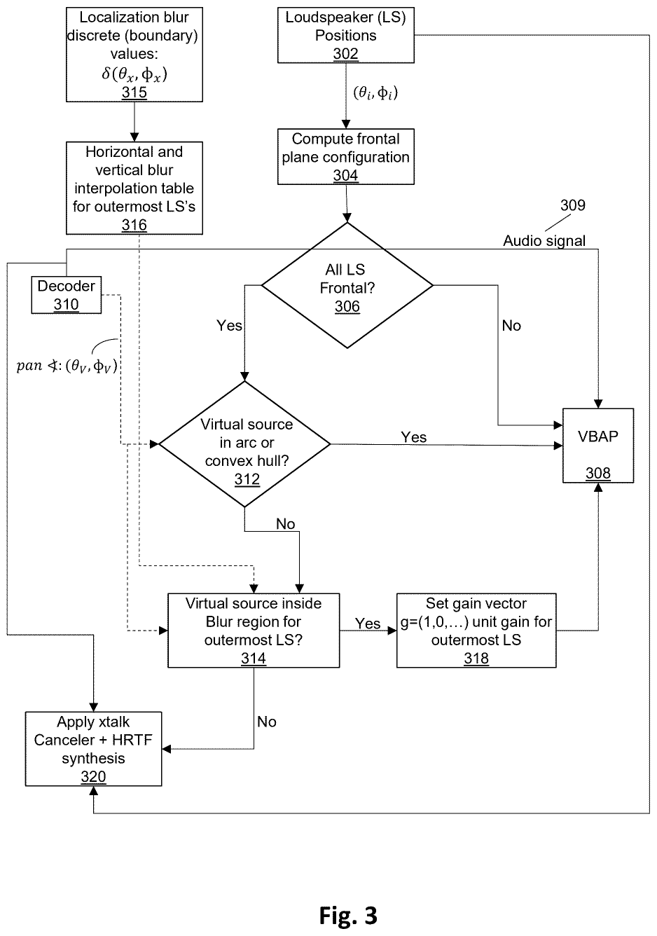

FIG. 2 illustrates an example implementation of the process of FIG. 1, and FIG. 3 illustrates an example implementation of a particular rendering selection process. In the example of FIG. 2, input audio 205 is accessed (e.g., received) and then decision block 210 determines whether the particular layout that will playback input audio 205 is a custom layout. If not, then default renderer 215 is used to render input audio 205. If yes, then modified rendering 220 is used, based on the custom layout specification 225 for the particular layout on which input audio 205 will be played.

FIG. 3 illustrates details of a particular rendering selection process. At step 302, loudspeaker positions are determined, e.g., based on their angular coordinates theta and phi. This is used in step 304 to compute the frontal plane configuration, and decision block 306 then determines whether all loudspeakers in the system are frontal. If not, then a VBAP rendering technique 308 may be used. VBAP, or vector based amplitude panning, is a technique in which a virtual sound source can be created anywhere on a line between two speakers (in 2D) or within a triangle (convex hull) in 3D, where each loudspeaker is at one corner of the convex-hull triangle. Here, the input audio signal 309 from decoder 310 is rendered using VBAP techniques 308.

If all speakers are frontal, then step 312 determines whether each virtual source speaker location is within the arc or convex all, i.e., whether each virtual source location can actually be created by the current loudspeaker layout. If so, then again VBAP rendering techniques 308 may be used. If not, then step 314 determines whether each virtual source region is within the localization blur region for the outermost loudspeakers. This step may be based on localization blur boundaries 315 and the horizontal and vertical blur interpolation tables 316 for the outermost loudspeakers. If decision block 314 is yes, then the outermost loudspeaker may receive a unit gain in the gain vector in step 318, and VBAP techniques 308 may be used. If decision block 314 is no, then step 320 may render the input audio signal 309 using crosstalk canceller and an HRTF (head-related transfer function), as is known in the art.

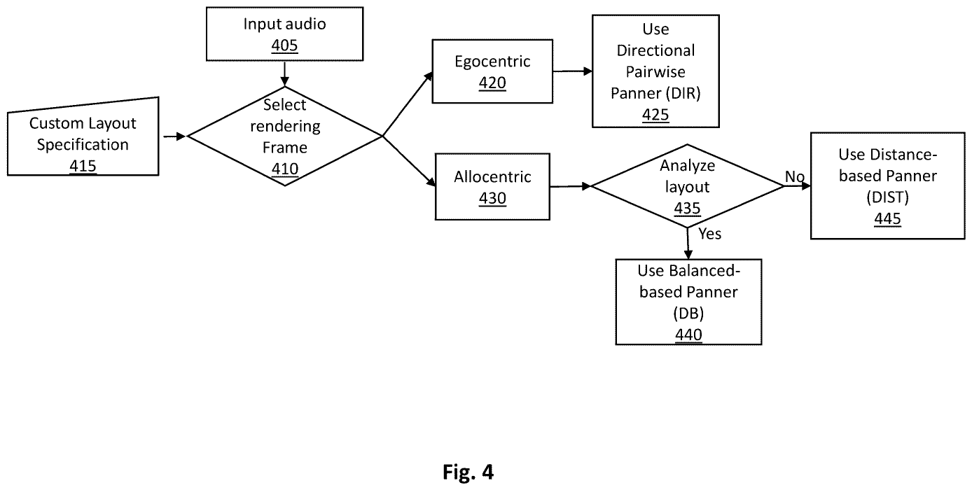

FIG. 4 illustrates example aspects of certain embodiments implementing the techniques of FIG. 1. In the example of FIG. 4, input audio 405 is accessed for a particular set of loudspeakers, and a custom layout has been determined (this step is not shown in FIG. 4). In particular embodiments, the decision of which modified renderer to use when a custom layout is present can occur on a frame-by-frame basis. For instance, the example of FIG. 4 illustrates an embodiment in which custom layout specification 415 is used for a particular audio frame 410 to determine what modified renderer will be used with the set of loudspeakers.

In addition or the alternative, particular embodiments may use different renderers for different portions of a loudspeaker system. For example, a first renderer such as an egocentric renderer 420 (e.g., using a directional pairwise panner 425, or using a VBAP renderer) may be used for a particular subset of loudspeakers in the system, while a second rendering technique (e.g., allocentric rendered 430) may be used for another section of the system. This may occur, for example, if portions of the system suitably match a particular specification for speaker placement, both other portions of the loudspeaker system do not. FIG. 4 illustrates a particular embodiment in which if an allocentric renderer 430 is used with a portion of a system, then the layout is analyzed in step 435 to determine whether the layout is sufficiently symmetric. If so, then a balanced based panner 440 may be used as the renderer; if not, then a DBAP or distance-based panner 445 may be used for that portion of the system.

FIG. 1 and the example implementations of FIGS. 2-4 may run at speaker setup, periodically, and/or if movement of a loudspeaker is detected (e.g., based on a recording of sounds played by the system or based on a sensor within the loudspeaker itself). In particular embodiments, a user may trigger any of the processes of FIG. 1-4, e.g., in order to recalibrate their system.

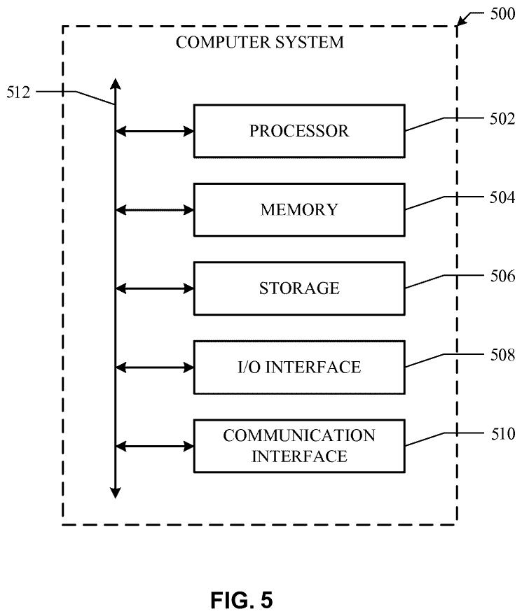

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure contemplates a system that includes one or more non-transitory computer readable storage media storing instructions; and one or more processors coupled to the one or more non-transitory computer readable storage media and operable to execute the instructions to perform certain functions includes embodiments in which those functions are performed by a single processor, embodiments in which those functions are performed by multiple processors that each perform all the functions, and embodiments in which those functions are performed by multiple processors (e.g., in separate computing devices) where each processor performs at least one function but less than all recited functions.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing input audio for playback on a set of loudspeakers having a particular layout in a listening space;
determining, based on the particular layout of the set of loudspeakers in the listening space, whether the particular layout comprises a custom layout that differs from a default layout associated with a default renderer for generating output audio for playback on the set of loudspeakers;
in response to a determination that the particular layout comprises a custom layout, then selecting, based on the particular layout of the set of loudspeakers, a modified renderer for generating output audio for playback on the set of loudspeakers; and
rendering the input audio using the selected modified renderer to generate the output audio for playback on the set of loudspeakers.

2. The method of claim 1, wherein the input audio comprises Cartesian metadata.

3. The method of claim 2, wherein the default renderer comprises an allocentric renderer.

4. The method of claim 3, wherein the modified renderer comprises an egocentric renderer.

5. The method of claim 2, further comprising determining, based on the particular layout, whether to generate the output audio using a vector-based amplitude panning renderer or by using a crosstalk canceller and HRTF synthesis.

6. The method of claim 1, further comprising determining, based on one or more recordings of one or more test audio from the set of loudspeakers, the particular layout in the listening space.

7. The method of claim 1, wherein the input audio comprises a frame of input audio.

8. The method of claim 1, further comprising:
selecting, based on the particular layout of a subset of the set of loudspeakers, a modified renderer for generating output audio for playback on the subset of loudspeakers; and
rendering the input audio using the selected modified renderer for audio playback on the subset of loudspeakers and rendering the input audio using a second renderer for audio playback on another portion of the set of loudspeakers.

9. A system comprising one or more non-transitory computer readable storage media storing instructions; and one or more processors coupled to the one or more non-transitory computer readable storage media and operable to execute the instructions to:
access input audio for playback on a set of loudspeakers having a particular layout in a listening space;
determine, based on the particular layout of the set of loudspeakers in the listening space, whether the particular layout comprises a custom layout that differs from a default layout associated with a default renderer for generating output audio for playback on the set of loudspeakers;
in response to a determination that the particular layout comprises a custom layout, then select, based on the particular layout of the set of loudspeakers, a modified renderer for generating output audio for playback on the set of loudspeakers; and
render the input audio using the selected modified renderer to generate the output audio for playback on the set of loudspeakers.

10. The system of claim 9, wherein the input audio comprises Cartesian metadata.

11. The system of claim 10, wherein the default renderer comprises an allocentric renderer.

12. The system of claim 11, wherein the modified renderer comprises an egocentric renderer.

13. The system of claim 10, further comprising one or more processors that are operable to execute the instructions to determine, based on the particular layout, whether to generate the output audio using a vector-based amplitude panning renderer or by using a crosstalk canceller and HRTF synthesis.

14. The system of claim 9, further comprising one or more processors that are operable to execute the instructions to determine, based on one or more recordings of one or more test audio from the set of loudspeakers, the particular layout in the listening space.

15. The system of claim 9, wherein the input audio comprises a frame of input audio.

16. The system of claim 9, further comprising one or more processors that are operable to execute the instructions to:
select, based on the particular layout of a subset of the set of loudspeakers, a modified renderer for generating output audio for playback on the subset of loudspeakers; and
render the input audio using the selected modified renderer for audio playback on the subset of loudspeakers and rendering the input audio using a second renderer for audio playback on another portion of the set of loudspeakers.

17. The system of claim 9, further comprising one or more processors that are operable to execute the instructions to, in response to a determination that the particular layout does not comprise a custom layout, then select the default renderer for generating output audio for playback on the set of loudspeakers.

18. One or more non-transitory computer-readable storage media storing instructions that are operable when executed by one or more processors to:
access input audio for playback on a set of loudspeakers having a particular layout in a listening space;
determine, based on the particular layout of the set of loudspeakers in the listening space, whether the particular layout comprises a custom layout that differs from a default layout associated with a default renderer for generating output audio for playback on the set of loudspeakers;
in response to a determination that the particular layout comprises a custom layout, then select, based on the particular layout of the set of loudspeakers, a modified renderer for generating output audio for playback on the set of loudspeakers; and
render the input audio using the selected modified renderer to generate the output audio for playback on the set of loudspeakers.

19. The media of claim 18, wherein the input audio comprises Cartesian metadata.

20. The media of claim 18, wherein the instructions are further operable when executed to, in response to a determination that the particular layout does not comprise a custom layout, then select the default renderer for generating output audio for playback on the set of loudspeakers.
